(19) United States
(12) Patent Application Publication
(10) Pub. No.: US 2023/0334405 A1
(43) Pub. Date: Oct. 19, 2023

(54) AUDIT ENGAGEMENT SYSTEM AND METHOD FOR IMPROVING ENGAGEMENT’S AUDIT QUALITY, EFFICIENCY, EFFECTIVENESS, AND PROFITABILITY

(71) Applicant: Capital Accounting Advisory, LLC, Ashburn, VA (US)

(72) Inventor: Natalya YASHINA, Ashburn, VA (US)

(73) Assignee: Capital Accounting Advisory, LLC, Ashburn, VA (US)

(21) Appl. No.: 18/130,829

(22) Filed: Apr. 4, 2023

Related U.S. Application Data
(60) Provisional application No. 63/331,040, filed on Apr. 14, 2022.

(51) Int. Cl. G06Q 10/0637; G06Q 10/0631

(52) U.S. Cl. CPC G06Q 10/0637; G06Q 10/063118

(57) ABSTRACT

A system and a method of structuring and operating audit engagements to reduce/eliminate the burden of administrative tasks from audit managers in order to improve audit quality, efficiency, effectiveness, and profitability. The system and method improve the current audit team formation process and structure by determining a total number of project managers needed for an audit practice and on individual audit engagements, without the need to increase the number of employees, by automatically aggregating the historical profitability and utilization data and performing the predetermined calculations using an automated algorithm.

### CROSS-REFERENCE TO RELATED APPLICATIONS

This application is based upon and claims the benefit of priority of the U.S. Provisional Patent Application No. 63/331,040, filed on Apr. 14, 2022, the entire contents of which are incorporated herein by reference.

### BACKGROUND OF THE INVENTION

### 1. Field of the Invention

Aspects of the present invention provide a system and method of improving audit team formation system and process by allowing audit managers to focus on audit quality and technical accounting matters related to audits without the need to increase overall audit firm's staffing. Aspects of the present invention relate to an audit engagement system to reduce and/or eliminate administrative burden from audit managers during an audit engagement.

### 2. Description of the Related Art

Over the years, Public Company Accounting Oversight Board (PCAOB) inspection reports demonstrate a trend of an increasing number of audits with deficiencies. Although recently there has been some progress and improvement, the PCAOB inspection reports continue to identify recurring deficiencies in areas such as internal control over financial reporting, revenue, accounting estimates, and others. In 2012, the PCAOB released Information for Audit Committees about the PCAOB Inspection Process document. It was noted in the document that the audit firm's management of its audit practice including the firm's management systems, structures and processes affect audit quality. Audit team formation and engagement system and the firm's processes have a direct impact on audit quality. Audits have become somewhat of a commodity and with that, companies often aren't willing to pay higher audit fees which can limit the firm's ability to hire additional audit staff. Furthermore, audit firms continue to experience never-ending staffing shortages fueled by many different reasons including the decreased number of accounting graduates nationwide. As a result, audit teams operate under significant human resource constraints that lead to increased overtime hours on many audit engagements. As most audit contracts are fixed in price, overtime hours only decrease profitability of audit engagements. More importantly, the administrative burden on audit engagement managers takes away critical hours that need to be dedicated to audit quality. Despite many audit firms' attempts to increase salary and benefits, including work-life balance and remote work benefits, the staffing shortage persists and the issues with audit engagements' quality, effectiveness, efficiency, and profitability continue to trouble the industry.

### SUMMARY OF THE INVENTION

The present invention provides a system and method of improving audit team formation process and structure by allowing audit managers to focus on audit quality and technical accounting matters related to audits without the need to increase overall audit firm's staffing. Aspects of the present invention relate to an audit engagement system and structure to reduce and/or eliminate administrative burden from audit managers during an audit engagement.

Current audit team formation and engagement systems assign and use audit managers as both, subject matter experts and project managers, which can often lead to audit engagement mismanagement that negatively impacts audit quality, engagement efficiency and effectiveness, and profitability.

According to embodiments of the present invention, the present innovative audit engagement system and structure remove administrative responsibilities from an audit manager on an audit engagement and adds a dedicated project manager expert (PME) role to the engagement's structure by automatically aggregating the historical profitability and utilization data and performing the predetermined calculations using a semi-automated algorithm to calculate the number of PMEs needed for the overall audit practice and on individual audit engagements.

The non-PME audit manager retains their responsibilities over technical accounting and audit matters associated with the audit engagements they are assigned to, and their role is defined as a subject matter manager expert (SMME). As a result, their time is now dedicated to audit specific tasks, audit quality, effectiveness and efficiency while the PME's time is dedicated to administrative tasks and profitability of audit engagements.

According to an embodiment of the present invention, a system, comprises: a database storing historical plural number of years profitability and audit managers' utilization averages for all engagements of a firm; a memory for storing application code; and a processor configured to use the application code to: determine a correlation coefficient using the profitability and the utilization averages using a linear regression formula; and determine a number of project manager experts (PMEs) needed for the firm by multiplying the correlation coefficient by a number of audit managers of the firm.

According to another embodiment of the present invention, a method comprises: storing historical plural number of years profitability and audit managers' utilization averages for all engagements of a firm; determining a correlation coefficient using the profitability and the utilization averages using a linear regression formula; and determining a number of project manager experts (PMEs) needed for the firm by multiplying the correlation coefficient by a number of audit managers of the firm.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view of an embodiment of the system and method of an audit engagement formation and structure.

FIG. 2 is a flowchart of the sequence of steps of initiating the process of audit engagement structure formation.

FIG. 3 is an example of PME calculation page view within a system/application.

FIG. 4 is an example of PME calculation results page view within a system/application.

FIG. 5 is an example of PME/SMME split calculation page view within a system/application.

FIG. 6 is an example of PME/SMME split calculation results page view within a system/application.

FIG. 7 is an example of HR/Compliance data page view within a system/application.

FIG. 8 is an example of a reporting hierarchy of the innovative engagement structure.

FIG. 9 is an example of a reporting hierarchy of the innovative engagement structure.

FIG. 10 is an example of a reporting hierarchy of the innovative engagement structure.

### DETAILED DESCRIPTION OF THE EMBODIMENTS

Particular aspects of the invention are described below for purposes of illustrating its principles and operation. However, various modifications may be made, and the scope of the invention is not limited to the exemplary aspects described.

The following are engagement roles definitions for the purposes of this invention.

Engagement partner, as defined by the Statement on Quality Management Standards No. 1, is referred to as the partner or other individual appointed by the firm who is responsible for the audit engagement and its performance, and for the report that is issued on behalf of the firm, and who, when required, has the appropriate authority from a professional, legal, or regulatory body.

Concurring partner is an engagement's quality reviewer, as defined by the Statement on Quality Management Standards No. 1. An engagement quality reviewer is a partner, another individual in the firm, or an external individual appointed by the firm to perform engagement quality review.

Audit manager is referred to as the manager or other individual in the firm who is responsible for managing both technical and administrative aspects of audit and other engagements and their delivery from planning through completion.

Project manager expert (PME) is referred to as the manager or other individual in the firm who is responsible for the administrative side of audit and other types of engagements and their performance and has met the minimum qualifications of a project manager expert. The minimum qualifications for a PME role are configured within the system 100 and include the following: an active CPA license, an unexpired DASM certification, 8 annual PDU training hours in project management, and a minimum of 2 years of experience in an audit manager role.

Subject matter manager expert (SMME) is referred to as the manager or other individual in the firm who is responsible for non-administrative (technical, accounting, auditing) aspects of audit and other types of engagements, and their delivery from planning through completion. They have a solid knowledge of auditing and accounting regulations and guidelines.

Senior associate oversees audit engagements, assists with planning and performing audits and other types of engagements, ensures that tasks are assigned to and completed by other auditors on the team, typically more junior. They work closely with team members to execute the audit plan and generally assist an audit manager by ensuring timely completion of the audit related tasks. They typically supervise associates and interns on a daily basis.

Associates and interns assist auditing team with their day-to-day tasks including but not limited to inspecting financial statements, performing test work, and other required tasks.

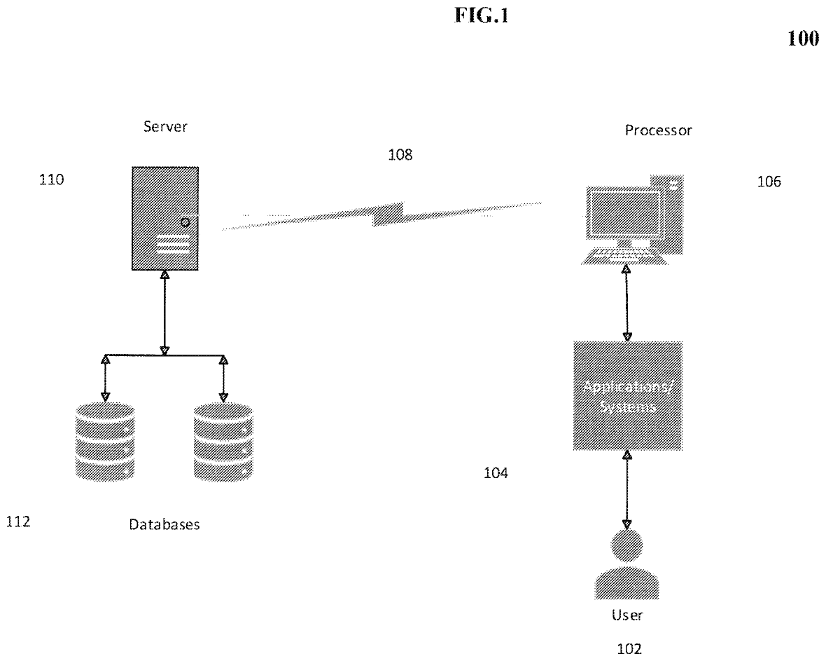

A system and method of determining the number of PMEs necessary for an entire audit practice, the split of hours between the PME and SMME, an overall reduction of hours on an audit engagement without adding additional full-time equivalents (FTEs) to the firm audit practice, and final innovative audit engagement systems and methods are shown in FIGS. 1-10 below.

Referring to FIG. 1, there is shown a perspective view of an embodiment of the system audit engagement formation system 100. The system 100 provides an application for supporting resource management systems/applications and/or HR/compliance systems and reporting. An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a non-transitory computer program designed to communicate with local and/or remote electronic devices. Embodiments of the present invention provide for a system and method for allowing a user to determine the actual need for project managers for an entire audit practice, reduce the number of hours spent on the engagement by SMMEs and add PME hours necessary on each engagement without adding additional FTEs to an audit practice.

In the embodiment, the system 100 consists of a user 102, application(s)/system(s) 104, a processor with a display 106, a network 108, a server 110, and databases 112 which are in-memory databases.

In an embodiment, application(s)/system(s) 104 may consist of a single HR/Compliance/Resource Management system or separate HR, Compliance, Resource Management (RM) systems and applications or any other relevant system and/or application that may or may not interface with one another.

The processor 106 may be a general-purpose central processing unit (CPU), implemented by at least one of electronic units such as an application-specific integrated circuit (ASIC), one or more integrated circuits, a digital signal processor (DSP), a programmable logic device (PLD), a field programmable gate array (FPGA), a processor, a controller, a microcontroller, and/or a microprocessor, or may be implemented by a software module that performs at least one function or operation.

The processor 106 may be a general-purpose central processing unit (CPU), implemented by at least one of electronic units such as an application-specific integrated circuit (ASIC), one or more integrated circuits, a digital signal processor (DSP), a programmable logic device (PLD), a field programmable gate array (FPGA), a processor, a controller, a microcontroller, and/or a microprocessor, or may be implemented by a software module that performs at least one function or operation.

The memory 114 (a non-transitory computer readable medium) may be a read-only memory (ROM) or another type of static storage device that can store static information and an instruction, a random access memory (RAM) or another type of dynamic storage device that can store information and an instruction, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be used to carry or store expected program code in a form of an instruction or a data structure and that can be accessed by a computer. However, the memory 114 is not limited thereto. The memory may exist independently and is connected to the processor 106 by using the communications bus. Alternatively, the memory 114 may be integrated with the processor 106.

The memory 114 is configured to store application program code for executing the foregoing and following methods and processes, and the processor 106 controls the execution thereof. The processor 106 is configured to execute the application program code stored in the memory 114.

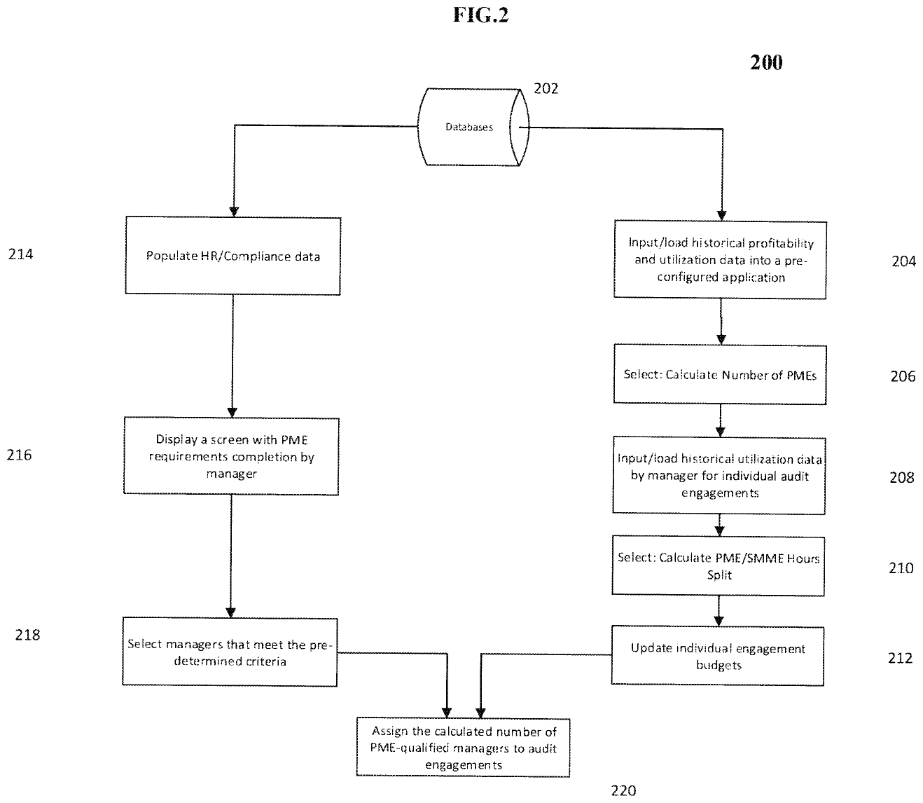

FIG. 2 illustrates an embodiment of a method of utilizing the application(s)/system(s). In step 204, the application within a system is initiated by a user. In step 204, the user inputs or loads historical profitability and audit teams' utilization data of all active audit engagements from databases 202 by initiating historical data load or by manually transferring available data into the preconfigured application(s)/system(s). Once the data is populated, a total number of PMEs for an audit practice is determined/calculated in step 206. In step 208, the user inputs or loads historical utilization data by audit manager, in case of the initial implementation, or by SMME for time periods following the initial implementation for individual audit engagements which then allows the system 100 to automatically determine the PME/SMME hours split and hours reduction on each individual engagement in step 210. In step 212, the user updates individual engagements' budgets either manually or, if configured within the system 100, by executing the system's 100 automatic engagement budget update process.

Separately, in step 214, the user populates HR/Compliance data for audit managers either from the same or a separate system or application. The data includes information about audit managers' qualifications, including their licensing status, project management certifications, training compliance, and other relevant information. The application then displays a screen with PME requirements completion by audit manager. In step 218, the user selects managers who meet the pre-determined criteria. In step 220, the user selects all PME-qualified managers to individual audit engagements to be assigned to individual audit engagements in step 220.

In step 220, outputs 212 and 218 are combined to assign qualified PMEs to audit engagements either manually, or, if configured by the system 100, by executing the system's 100 automatic engagement assignment process.

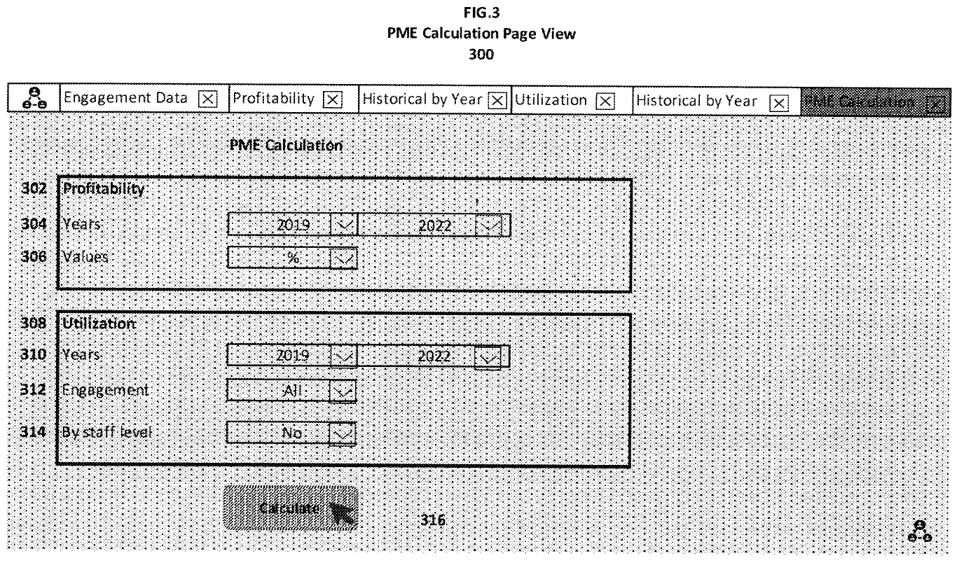

FIG. 3 illustrates an embodiment of a screenshot/page depicting the details of PME calculation 300 as determined in step 206. The determination/calculation uses historical profitability of all audit engagements 302 within an audit practice for a specific number of years 304, with profitability expressed as a percentage of net engagement income 306 for purposes of the calculation. Average historical staff 314 utilization 308 on all audit engagements 312 is one of the inputs in the calculation. In an embodiment, the PME calculation page 300, also includes calculate button 316 to make the calculation.

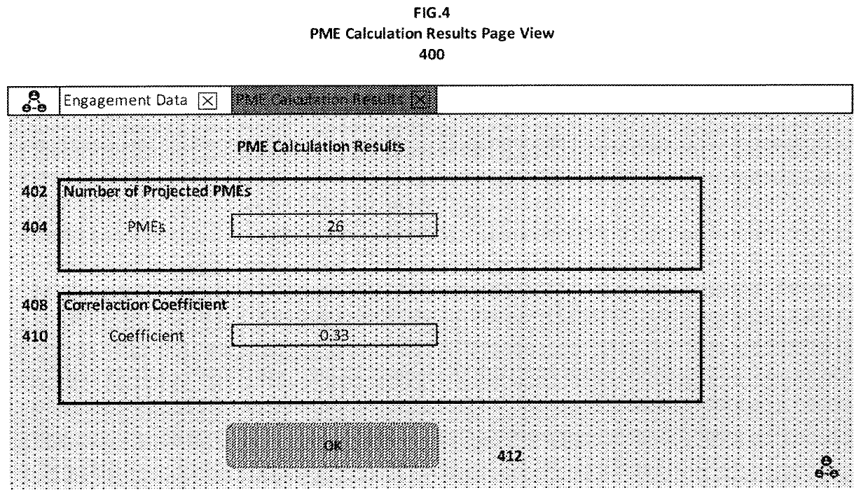

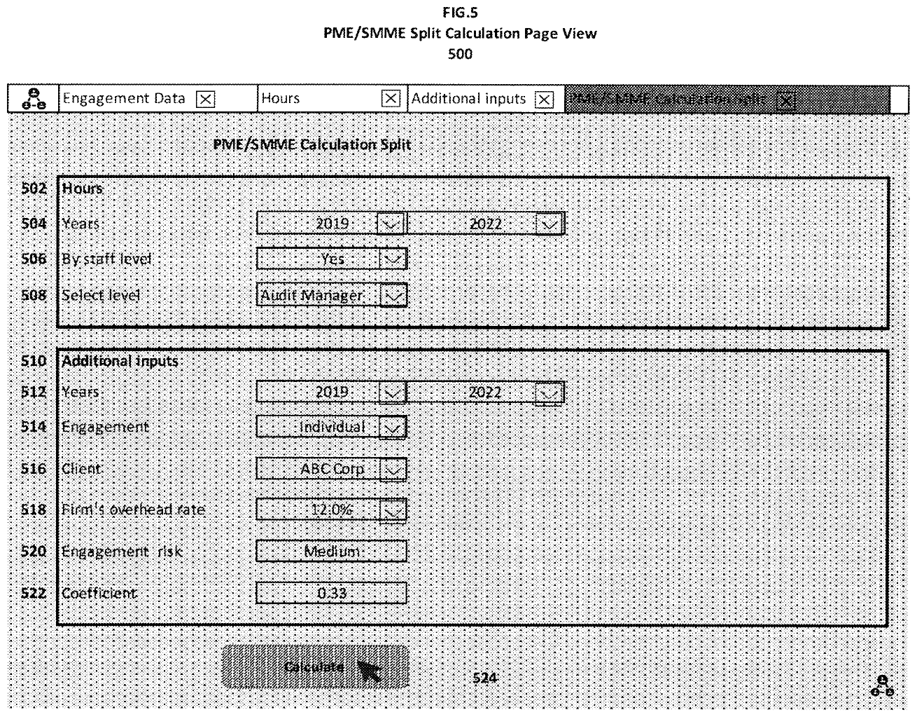

FIG. 4 illustrates an embodiment of a screenshot/page depicting PME calculation results 400. The screenshot/page displays the number of projected PMEs 402, 404, and a correlation coefficient 408, 410. The coefficient represents a degree of correlation between an audit firm's profitability and staff's utilization, and it drives the determination of the number of PMEs needed for an audit practice. The greater the staff's utilization, the less profitable is the firm's audit practice. In this example, the system is configured to use the absolute value of the results of Pearson's correlation coefficient formula:

$$r = \frac{n ( \sum xy ) - ( \sum x ) ( \sum y )}{√ [ n \sum {x}^{2} - {( \sum x )}^{2} ] [ n \sum {y}^{2} - {( \sum y )}^{2} ]} ,$$

where x and y represent two sets of data, profitability and utilization of all audit engagements on an individual basis. However, the system 100 can be configured to use a coefficient formula that would be most applicable for an audit practice. In an embodiment, the PME calculation results page 400, also includes ok button 412, that takes the user to the PME/SMME split calculation screenshot/page in FIG. 5.

FIG. 5 illustrates an embodiment of a page depicting a PME/SMME split calculation and the relevant inputs 500. This page is displayed after the user completes the steps in FIG. 3 and FIG. 4. The user completes the calculation by filling out the Hours section 502 which represents average audit managers' hours for a period specified by the user. The user then enters/selects additional inputs 508 including years range for which the average engagement data 512 is needed, the type of engagement (individual or all engagements) 514, the client's name 516, the audit firm's overhead rate 518, the engagement risk level 520, and the coefficient 522. The years range 504, 512 is the same as in FIG. 3, 304, 310. The calculation utilizes the hours 502, by staff level 506, specifically, by audit manager 508, on an individual engagement 514 for a client 516. An audit firm's overhead rate 518 is an established firm-wide rate (surcharge) that is typically added to an audit engagement's budget. Engagement risk 520 represents a risk level assigned to a client during client acceptance and continuance assessment and the system 100 is configured to automatically pull this information from the client's acceptance and continuance assessment system. The coefficient 522 is automatically populated from PME calculation results page in FIG. 4. In an embodiment, the PME/SMME calculation page 500 also includes calculate button 522 to actually make the calculation.

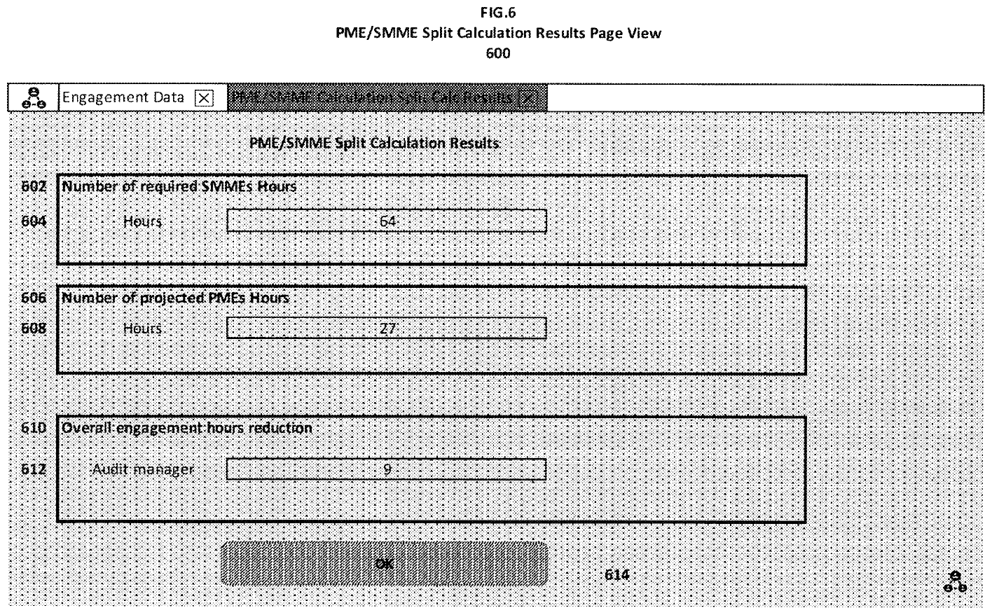

FIG. 6 illustrates an embodiment of a page depicting PME/SMME split calculation results 600. This page is displayed after the user completes the steps in FIG. 5. The page displays the number of required SMMEs' hours 602,604 and the number of projected PMEs' hours on an individual audit engagement 606, 608. The system automatically calculates the overall engagement hours reduction 610 for an audit manager 612. In an embodiment, the PME/SMME calculation results page 600, also includes ok button 614 that stores the results of calculations into the system.

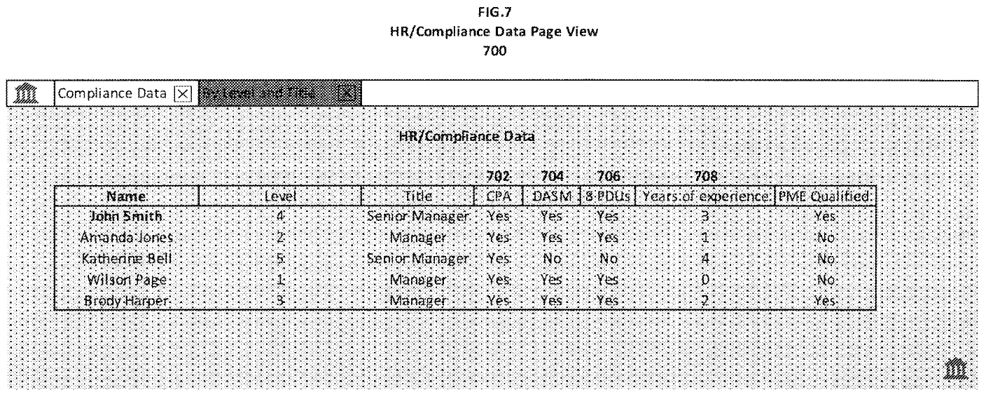

FIG. 7 illustrates an embodiment of a screenshot/page depicting HR/Compliance data 700. The system 100 is configured to pull the minimum required licenses 702, certifications 704, training 706, and experience 708 from the database 112, and display whether an audit manager is qualified for a PME role on an audit engagement. The user can view this screenshot/page and proceed with the assignment of PME qualified managers to audit engagements. The minimum qualifications for a PME role are configured within the system 100 and include the following: an active CPA license, an unexpired DASM certification or/and other relevant project management certification, 8 annual PDU training hours in project management, and a minimum of 2 years of experience in an audit manager role.

Hypothetical Scenario

The following is a hypothetical scenario, just by way of example, of how the system 100 and the method 200 operate.

An audit firm (“the firm” or “audit practice”) was facing several issues related to audit quality and profitability as they did not pass several PCAOB and peer review inspections and experienced a continuous staffing shortage, increased turnover and work hours, and a dwindling pipeline of accounting graduates, the firm was facing an ongoing problem specific to the audit profession. Their pricing structure was fixed fee, which was typical and comparable to other audit firms. Thus, with increased hours and salaries, the profitability of audit engagements tanked. The firm decided to implement an innovative audit team system/structure. The innovative audit team structure was directed at a modification of their existing audit team structure by adding an additional project manager expert (PME) role without adding additional employees or FTEs (full-time equivalent) and reducing the overall hours spent by audit managers on audit engagements, which would lead to an increased profitability. This was achieved by isolation of relevant historical data and current data from the firm's databases and performing a specific sequence of steps described below. All the steps described were configured within the system 100 and generally require limited user involvement to execute tasks (the method 200) within the system.

The existing audit team structure placed an undue administrative burden on audit managers and the firm implemented the innovative audit team system which allowed to remove administrative responsibilities from audit managers, determine the number of project manager experts that would be needed for their firm, and determine the overall reduction in audit managers' hours on audit engagements.

The firm had 250 current audit engagements and 80 managers who performed both subject-matter expert and administrative responsibilities on audit engagements. Each manager was responsible, on average, for 3 audit engagements per year (250/80).

The first step included pulling historical three-year profitability 302 and audit teams' utilization averages 308 for all engagements and calculating correlation between profitability and utilization, using a linear regression formula, i.e., Pearson's correlation. The processor 106, based on the application code stored in the memory 114, was configured to perform this calculation. The processor 106 calculated the correlation coefficient of 0.33 410 which indicated a negative relationship between profitability and utilization. The correlation coefficient drove the determination of the number of PMEs (26) 404 needed for the overall audit firm (80 audit managers×0.33 correlation coefficient=26).

The processor 106 calculated overall subject matter manager expert (“SMME”) hours 604 on an individual audit engagement, projected PME hours 608 on an individual audit engagement, and total reduction in managers' hours in one screen view. The first step in this configuration was a calculation of an adjustment to audit manager's hours. The system was configured for a user to pull an audit manager's 3-year average utilization (in hours) 502 on an individual audit engagement, multiply it by the firm's current overhead rate 518, and then divide the result by the correlation coefficient 522 that was determined from an earlier step 410 using Pearson's correlation formula configured within the system. The result was then subtracted from the 3-year average utilization 502 (100 hours) to determine the final hours necessary 604 (64 hours) for an audit manager who would be assigned an SMME role on an audit engagement. In this case, the 3-year utilization average was 100 hours (which was automatically calculated in the background by the processor once PME/SMME Split Calculation in FIG. 5 was initiated by the user) which was then multiplied by the firm's current overhead rate 518 of 12% and the result was divided by the correlation coefficient 522 of 0.33 which yielded to 36.4 hours.

The processor 106 then subtracted 36 hours (rounded) from 100 hours (3-year average utilization) which resulted in 64 hours (rounded), 604. Now, the audit manager was assigned an SMME role, and their hours were updated from 100 to 64, 604.

All audit engagements are assigned a risk level associated with a particular client during client acceptance and continuance stage. Typically, the risk ranges from low to high. The adjustment to the audit manager's hours (in this case it was 36 hours), was then further adjusted by the risk level associated with a particular client. Different percentages associated with the level of risk were assigned to each level within the system based on the facts and circumstances associated with the firm's overall client acceptance and continuance process. In this case the risk associated with the client was medium and the risk level percentage associated with it was 25%. As a result, projected PME hours were automatically adjusted to 27 hours (rounded), 608. Thus, the total reduction in overall manager level hours on this audit engagement was 9 (36-27), 612, and it was achieved without adding any additional employees (full-time equivalents) to the firm. The same method is applied to the remaining audit engagements within the firm to quantify the total reduction in manager-level hours and project an increase in profitability without adding additional employees to the firm and audit engagements.

Finally, the firm needed to determine the PME's eligibility from a pool of their audit managers using predetermined criteria which included but wasn't limited to an active CPA license, an unexpired DASM and/or other relevant project management certifications noted previously, annual project management training requirements, and at least two years of experience as audit manager.

A report was generated from an HR/Compliance management system 700 which was configured to gather and track the aforementioned information and automatically determine one's eligibility for a PME role. After the report was generated, it was reviewed and PMEs were assigned to audit engagements.

In summary, the firm is now able have their audit managers' focus 100% on technical audit questions and audit-related responsibilities and all relevant administrative tasks associated with audit engagements are transferred to PMEs, which is expected to improve audit quality and address issues associated with PCAOB and peer inspections and reviews. Further, the firm can now increase their profitability despite having fixed fee audit contracts.

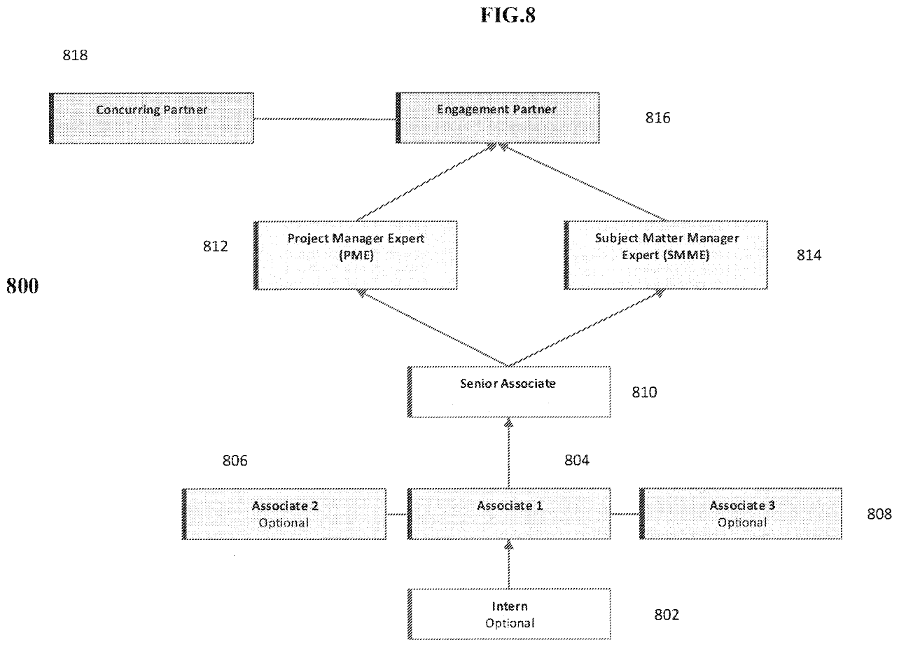

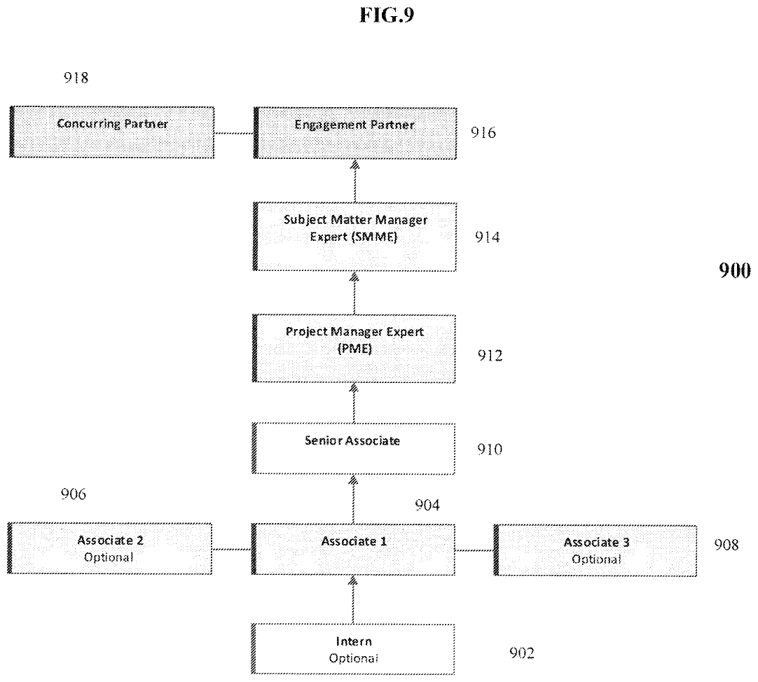

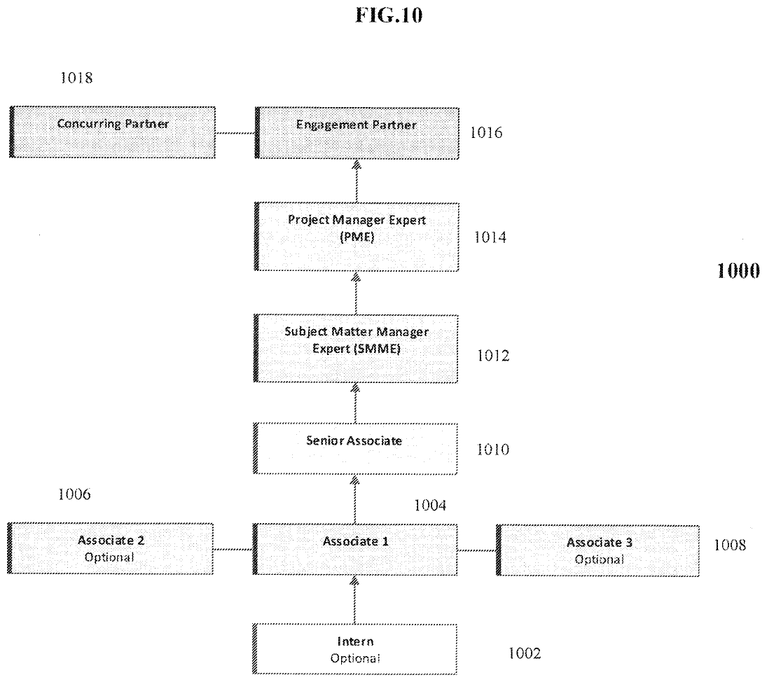

FIG. 8 is a flowchart depicting a reporting hierarchy of the innovative engagement structure 800. The reporting structure can be modified based on an audit engagement's needs with additional examples of a reporting hierarchy shown in FIG. 9 and FIG. 10. The innovative piece of this structure incorporates a project manager expert (“PME”) role 812 on an audit engagement, removes administrative responsibilities from an audit manager who now becomes a subject matter manager expert (“SMME”) 814, and reduces the number of hours spent on the audit engagement by the SMME without adding additional full-time equivalents (“FTE”) to an audit practice. In this example, PME and SMME are peers and both report directly to an engagement partner. The rest of the audit engagement structure remains unchanged and typically consists of an intern 802, one or more associates 804, 806, 808, a senior associate 810, an engagement partner 816, and a concurring partner 818. It is to be noted that there may be other specialists or additional senior associates or managers scheduled on an audit engagement and the number of staff/managers depends on a client's complexity and reporting requirements.

FIG. 9 is a flowchart of another example of an audit engagement's reporting structure that incorporates a project manager expert (“PME”) role 912. The reporting structure can be modified based on an audit engagement's needs with additional examples of reporting hierarchies shown in FIG. 8 and FIG. 10. The innovative piece of this structure incorporates a project manager expert (“PME”) role 912 on an audit engagement, removes administrative responsibilities from an audit manager who now becomes a subject matter manager expert (“SMME”) 914, and reduces the number of hours spent on the audit engagement by the SMME without adding additional full-time equivalents (“FTE”) to an audit practice. In this example, the PME reports directly to the SMME, meaning that the SMME is senior to the PME as only the SMME then reports directly to an engagement partner. The rest of the audit engagement structure remains unchanged and typically consists of an intern 902, one or more associates 904, 906, 908, a senior associate 910, an engagement partner 916, and a concurring partner 918. It must be noted that there may be other specialists or additional senior associates or managers scheduled on an audit engagement and the number of staff/managers depends on client's complexity and reporting requirements.

FIG. 10 is a flowchart of another example of an audit engagement's reporting structure that incorporates a project manager expert (“PME”) role 1014. The reporting structure can be modified based on an audit engagement's needs with additional examples of reporting hierarchies shown in FIG. 8 and FIG. 9. The innovative piece of this structure incorporates a project manager expert (“PME”) role 1014 on an audit engagement, removes administrative responsibilities from an audit manager who now becomes a subject matter manager expert (“SMME”) 1012, and reduces the number of hours spent on the audit engagement by SMME without adding additional full-time equivalents (“FTE”) to an audit practice. In this example, the SMME reports directly to the PME, meaning that the PME is senior to the SMME as only the PME then reports directly to an engagement partner. The rest of the audit engagement structure remains unchanged and typically consists of an intern 1002, one or more associates 1004, 1006, 1008, a senior associate 1010, an engagement partner 1016, and a concurring partner 1018. It is noted that there may be other specialists or additional senior associates or managers scheduled on an audit engagement and the number of staff/managers depends on client's complexity and reporting requirements.

As noted above, a current audit engagement team structure does not use a separate PME role to run the administrative side of audit engagements. Instead, audit managers are responsible for all technical and administrative aspects of their assigned audit engagement.

Embodiments of the present invention improve upon what currently exists. Changing a current audit engagement structure by adding a PME who shoulders the administrative responsibilities of an audit engagement helps to address audit quality, efficiency, effectiveness, and profitability issues that are prevalent within the profession. Embodiments of the present invention allow SMMEs to fully focus on technical accounting issues, audit file review, and other audit related matters. Improved profitability can also be mathematically assessed and determined.

Embodiments of the invention can also produce:
1. an audit project management add-on to existing audit software;
2. client billing and fee collection systems;
3. separate project management software that is integrated with primary audit software;
4. a time tracking application and/or software that is integrated with audit software; and
5. an automated method of assigning PMEs and SMMEs to audit engagements.

It is recommended that the steps of the method be sequential. While it is still possible to achieve a similar result by changing the order of the steps, the result may not have the same level of improvement in audit quality, audit engagement efficiency, effectiveness, and profitability. It is possible to assign a part-time project manager expert (“PME”) on a part-time consulting basis to audit teams, who also continues to be responsible for some engagements as a subject matter manager expert (“SMME”). This scenario can possibly lead to a decrease in audit quality, efficiency, effectiveness, and profitability, but is still possible. The PME will not be able to solely focus on their administrative responsibilities to produce the highest degree of positive impact on assigned audit engagements.

While it is possible to assign an inexperienced manager (less than 2 years of experience as audit manager) to a PME role on an audit engagement, their lack of subject matter expertise and experience with a variety of technical audit issues may negatively impact profitability, effectiveness, efficiency.

According to an embodiment of the present invention, becoming a project manager expert (“PME”) on an audit engagement has several requirements: 1) active CPA license, 2) experience as a subject matter manager expert, i.e., performing audits at a manager level and having exposure to a variety of audit issues and technical matters for at least two years, 3) unexpired DASM certification, and 4) completion of 8 project management PDUs on an annual basis.

The PME will utilize their project management skills, knowledge of various project management techniques and audit management as well as their subject matter expert experience (from previously working as an audit manager on audit engagements) to run the administrative side of audit engagements.

Thus, based upon the foregoing, aspects of the present invention provide a system and method of improving audit team formation system and process by allowing audit managers to focus on audit quality and technical accounting matters related to audits without the need to increase overall audit firm's staffing. Consequently, administrative burden is reduced and/or eliminated from audit managers during an audit engagement.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A system, comprising:
a database storing historical plural number of years profitability and audit managers' utilization averages for all engagements of a firm;
a memory for storing application code; and
a processor configured to use the application code to:
determine a correlation coefficient using the profitability and the utilization averages using a linear regression formula; and
determine a number of project manager experts (PMEs) needed for the firm by multiplying the correlation coefficient by a number of audit managers of the firm.

2. The system according to claim 1, wherein the linear regression formula is Pearson's correlation.

3. The system according to claim 1, wherein the processor is further configured to:
determine an adjustment to one of the audit managers hours by:
pulling, from the database, the audit manager's plural number of years utilization average on an individual engagement; and
determining an unadjusted number of PME hours by which the audit manager hours need to be reduced for the audit manager to be assigned a subject matter manager expert (SMME) role using the utilization average, a current overhead rate of the of the firm and the correlation coefficient.

4. The system according to claim 3, wherein the processor is further configured to determine a number of hours necessary for the audit manager to be assigned a subject matter manager expert (SMME) role by:
multiplying the utilization average by the current overhead rate to determine a first result,
dividing the first result by the correlation coefficient to determine a second result; and
subtracting the second result from the average utilization hours to determine the number of hours for the audit manager to be assigned the SMME role.

5. The system according to claim 4, wherein the processor is further configured to:
receive a risk level associated with a client of the individual engagement;
determine an adjustment to the unadjusted PME hours by multiplying unadjusted PME hour by the risk level associated with a client of the individual engagement; and
adjust the unadjusted PME hours by subtracting the adjustment number from the unadjusted PME hours.

6. The system according to claim 5, wherein the processor is further configured to:
determine the adjustment to the remaining audit engagements of the firm to quantify a total reduction in manager level hours.

7. The system according to claim 1, wherein the processor is further configured to:
receive HR/compliance data from the database;
apply the HR/compliance data to a plurality of managers of the firm; and
indicate which of the audit managers meets each criterion for PME.

8. The system according to claim 7, wherein the database stores relevant information for a PME-qualified manager which are:
an active CPA license, an unexpired DASM certification and/or other relevant project management certification, 8 annual PDU training hours in project management, and a minimum of 2 years of experience as an audit manager.

9. The system according to claim 5, wherein the processor is further configured to:
receive HR/compliance data from the database;
apply the HR/compliance data to a plurality of managers of the firm; and
indicate which of the audit managers meets each criterion for PME.

10. The system according to claim 9, wherein the database stores relevant information for a PME-qualified manager which are:
an active CPA license, an unexpired DASM certification and/or other relevant project management certification, 8 annual PDU training hours in project management, and a minimum of 2 years of experience as an audit manager.

11. A method, comprising:
storing historical plural number of years profitability and audit managers' utilization averages for all engagements of a firm;
determining a correlation coefficient using the profitability and the utilization averages using a linear regression formula; and
determining a number of project manager experts (PMEs) needed for the firm by multiplying the correlation coefficient by a number of audit managers of the firm.

12. The method according to claim 11, wherein the linear regression formula is Pearson's correlation.

13. The method according to claim 11, further comprising:
determining an adjustment to one of the audit managers hours by:
pulling, from the database, the audit manager's plural number of years utilization average on an individual engagement; and
determining an unadjusted number of PME hours by which the audit manager hours need to be reduced for the audit manager to be assigned a subject matter manager expert (SMME) role using the utilization average, a current overhead rate of the of the firm and the correlation coefficient.

14. The method according to claim 13, further comprising:
determining a number of hours necessary for the audit manager to be assigned a subject matter manager expert (SMME) role by:
multiplying the utilization average by the current overhead rate to determine a first result,
dividing the first result by the correlation coefficient to determine a second result; and
subtracting the second result from the average utilization hours to determine the number of hours for the audit manager to be assigned the SMME role.

15. The method according to claim 14, further comprising:
receiving a risk level associated with a client of the individual engagement;
determining an adjustment to the unadjusted PME hours by multiplying unadjusted PME hour by the risk level associated with a client of the individual engagement; and
adjusting the unadjusted PME hours by subtracting the adjustment number from the unadjusted PME hours.

16. The method according to claim 15, further comprising:
determining the adjustment to the remaining audit engagements of the firm to quantify a total reduction in manager level hours.
